(19) United States
(12) Patent Application Publication
(10) Pub. No.: US 2007/0195143 A1
(43) Pub. Date: Aug. 23, 2007

(54) Microfilter manufacture process

(75) Inventor: John Richard Andrews, Fairport, NY (US)

Correspondence Address: PILLSBURY WINTHROP SHAW PITTMAN, LLP, P.O. BOX 10500, MCLEAN, VA, 22102, US

(73) Assignee: XEROX CORPORATION, Stamford, CT (US)

(21) Appl. No.: 11/356,034

(22) Filed: Feb. 17, 2006

(51) Int. Cl. B41J 2/175

(52) U.S. Cl. 347/93

(57) ABSTRACT

A method of manufacturing a thermoplastic microfilter is presented. The method includes structuring a thermoplastic film to have a plurality of micro-indentations in which each indentation defines a cavity on a bottom side of the film and a thinned film layer on a top side of the film and removing the thinned film layer to form filter apertures in the thermoplastic film.

### BACKGROUND OF THE INVENTION

1. Field of Invention

The present disclosure relates to a method for manufacturing a thermoplastic microfilter.

2. Description of Related Art

Microfilters and microfiltration processes have been employed in a wide variety of fields and applications, including microfluidic and macrofluidic applications in biology, drug delivery, analytical chemistry, microchemical reactors and synthesis and genetic engineering as well as applications in homeland security and printing technologies. In general, microfilters are filtering devices configured to remove contaminants or particles on the order of microns from a fluid or gas by passage through a porous membrane or screen.

By way of illustration, consider how microfilters are employed in printing technologies, such as, for example, ink jet printers. Typically ink jet printers create a printed image by ejecting ink through apertures contained in an ink jet printhead onto an image receiving medium. An example of a suitable ink jet printhead is found in U.S. Pat. No. 5,677,718. FIG. 4A illustrates a front plan view of a printhead screen (aperture plate) 52 that forms part of an ink jet printhead. As indicated in FIG. 4A, the aperture plate 52 includes multiple rows of multiple apertures 50.

The printhead ejects ink from apertures 50 to create an image on an intermediate transfer surface. That is, as depicted in FIG. 4B, printhead screen 45 of a ink jet printhead 44 applies ink to image transfer drum 46. Image transfer drum 46 then transfers the images to substrate 40 under pressure from pressure roller 38. The image receiving medium may take the form of a sheet of media or an intermediate transfer drum that transfers the image to a sheet of media, such as a sheet of paper. 100051 Generally, thermally-actuated, drop-on-demand ink jet printing systems employ thermal energy pulses to produce vapor bubbles in an ink-filled channel that expels droplets from the channel nozzles of the printing system's printhead. Such printheads have one or more ink-filled channels communicating at one end with a relatively small ink supply chamber (or reservoir) and having a nozzle at the opposite end. A thermal energy generator, usually a resistor, is located within the channels near the nozzle at a predetermined distance upstream therefrom. The resistors are individually addressed with a current pulse to momentarily vaporize the ink and form a bubble which expels an ink droplet.

Other ink jet printing systems, such as a piezo-actuated printing system, utilize the deformation of a piezoelectric element to discharge ink. Generally, in such systems, pressurized ink is squirted through nozzles in the printhead by charging the piezoelectric element located behind the nozzles with electricity. The piezoelectric element vibrates when charged thereby pulling and then pushing the ink within the nozzle. By varying the strength of the electrical charges, the technology causes different-sized ink droplets to break away from the nozzle.

In either of these systems, because the dimensions of the ink inlets to the die modules are much larger than the ink channels, it is desirable to provide a filtering mechanism to avoid blockages and air bubbles during the flow of ink. To this end, filtering mechanisms are employed to filter the ink at some point along the ink flow path to prevent blockage of the channels by various particles or contaminants or air bubbles that may be carried in the ink. Even though some particles of a certain size do not completely block the channels, they can adversely affect directionality of a droplet expelled from the printheads.

Microfilters may be made from a variety of materials, including polymers and metals. Stainless steel particle filters, known as “rock screens,” used in conjunction with many types of ink jet printers, may be created by chemical etching. In one fabrication technique, a resistance patterned etch mask is used to form channels. In another fabrication technique, the filter is formed by a laser ablation process in which output laser radiation is directed through a mask system or light transmitting system to create a filter hole pattern.

With this said, it will be appreciated that many of the methods used in manufacturing such microfilters have proven to be relatively expensive.

### SUMMARY OF THE INVENTION

Principles of the present invention, as embodied and broadly described herein, provide for a method of manufacturing a thermoplastic microfilter. In one embodiment, the method includes structuring a thermoplastic film to have a plurality of micro-indentations in which each indentation defines a cavity on a bottom side of the film and a thinned film layer on a top side of the film and then removing the thinned film layer to form filter apertures in the thermoplastic film.

In some embodiments, the structuring of the thermoplastic film may comprise embossing the thermoplastic material to produce the micro-indentations. In other embodiments, the structuring may be performed by casting a thermoset material on a mandrel and then polymerizing the cast material. In yet other embodiments, the thermoplastic film may be structured by molding the film and then stamping the film.

In some embodiments, the removal of the thinned film layer may comprise selectively ablating the thin top side material via a laser ablation technique. In other embodiments, wet chemical etching, such as, for example, a potassium hydroxide etch bath may be used to remove the thinned areas. In yet other embodiments, plasma etching or reactive ion etching may be another way to remove the thinned areas.

### BRIEF DESCRIPTION OF THE DRAWINGS

The accompanying drawings, which are incorporated in and constitute a part of the present patent specification, depict corresponding embodiments of the invention, by way of example only, and it should be appreciated that corresponding reference symbols indicate corresponding parts. In the drawings:

FIG. 1 is a simplified diagrammatic illustration of a method for forming a thermoplastic filter comprising micro apertures;

FIG. 2 is a top surface view of a microfilter embodiment of the present invention;

FIG. 3 is a simplified diagrammatic illustration of an embossing and ablation system for the continuous manufacture of microfilters; and

FIGS. 4A, 4B (PRIOR ART) illustrate various components of a solid ink printer.

### DETAILED DESCRIPTION OF THE INVENTION

As will be evident by the ensuing detailed description, the present invention provides a method of manufacturing a microfilter. The microfilter structure comprises a thermoplastic film having a relatively planar top surface and a relatively planar bottom surface, the bottom surface comprising a plurality of micro-indentations, and the top surface comprising a plurality of filter apertures in communication with the bottom surface indentations.

The method of manufacturing such a microfilter comprises structuring a thermoplastic film having micro-indentations in which, on a top side, areas that will eventually define filter apertures are thinned and on a bottom side, cavities are exposed. Then, a bulk removal method is used to remove the thinned film material uniformly until the thinned areas are opened to define the filter apertures.

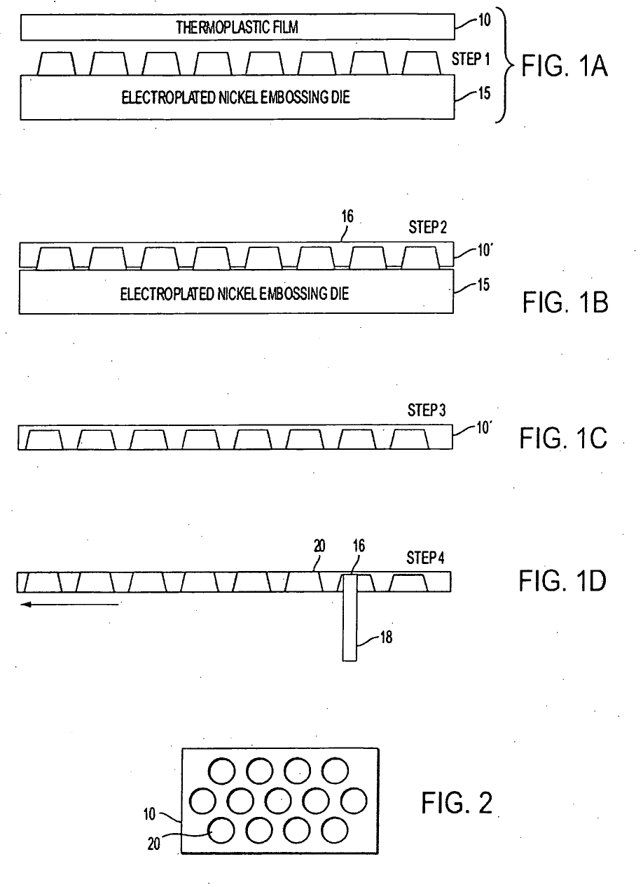

FIGS. 1A-1D illustrate one embodiment for manufacturing a thermoplastic microfilter 10 that comprises a plurality of filter apertures 20, as seen in FIG. 2. Although the diameter of the filter apertures 20 will clearly vary with specific applications and desired filter densities, by way of example only, the diameter of filter apertures 20 may be on the order of 8-15 μm.

In this embodiment, the structure of the microfilter 10 is achieved by having the thermoplastic film 10 brought in communication with an embossing die 15. As shown in FIG. 1A, embossing die 15 is configured with suitable protrusions in order to form micro-indentations in desired locations on film 10.

As illustrated in FIG. 1B, the thermoplastic film 10 and/or embossing die 15 is heated and the film 10 and die 15 are contacted with one another to form the micro-indentations in thermoplastic film 10′.

The embossed thermoplastic film 10′ is then cooled and, as depicted in FIG. 1C, the embossed thermoplastic film 10′ contains a structure in which the indented portions form cavities defining a thinned top side of the film 16 while the non-indented portions substantially remain at the pre-embossed thickness. Once again, although the dimensions of the film structure will clearly vary with specific applications and desired filter densities, by way of example only, the film structure may be configured so that the thinned top side 16 may be on the order of several micrometers (e.g., 2-3 μm) while the non-indented portions may be on the order dozens or so micrometers (e.g., 12-24 μm).

As illustrated in FIG. 1D, after cooling, embossed thermoplastic film 10′ is brought into check with a removal mechanism, in this case, an ablating device 18, such as, for example, a laser. The laser is configured to uniformly remove the thinned top surface 16 of the embossment to define the filter apertures 20 in the desired areas of microfilter 10.

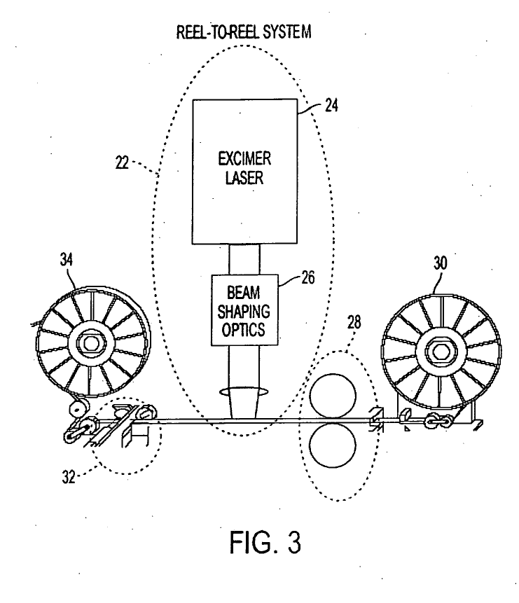

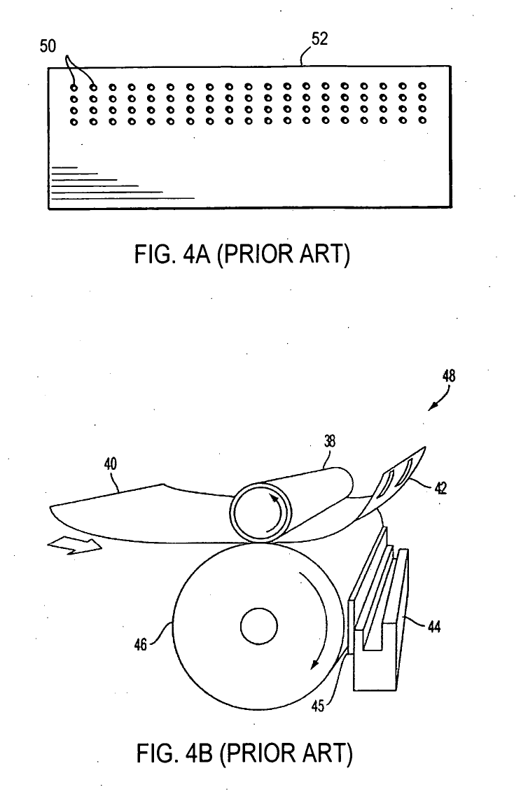

FIG. 3 illustrates a system for manufacturing microfilters 10 of FIG. 2 in a cost-effective, efficient, and continuous (i.e., “bulk”) manner. In such system, a continuous thermoplastic film 10 is wound about two reels: a material take-up reel 34 dispensing material and a material feed-out reel 30 taking up material. Thermoplastic film 10 moves through an embossing station 28, comprising a rotary embossing die, wherein micro-embossments are made (not shown).

Thermoplastic film 10 then moves past an ablation system 22, such as, for example, an excimer laser 24 with beam shaping optics 26 to remove the material from the micro-embossments to open the filter apertures 20. The film material is then taken up on material take-up reel 34 after passing through optical inspection system 32.

In the disclosed system, an KrF excimer laser may be employed that emits less than about 500 mJ per pulse, for example, about 400 mJ per pulse at 200 Hz, and an ablation fluence of less than about 600 mJ/cm². At an ablation fluence of 500 mJ/cm², a 0.5 cm² processing area may be obtained at any one time. Assuming 20 pulses to remove the thinned material layer (e.g., less than 5 micrometers in thickness) over the indentations gives a process speed of 20 mm/s for a 25 mm wide process zone. Therefore, one such nominal system might be employed to process ˜5 printheads/minute that are 9″ (229 mm) in length. In an alternative embodiment, an XeCl excimer laser may also be employed. Thus, by structuring the thermoplastic film with indentations having thinned top sides, the removal process for creating the filter apertures is simplified and can be executed in an efficient and cost-effective manner.

It is noted that the thermoplastic material may be ablated against a solid backing. The solid backing may prevent partially cut flaps of material from folding out of sight of the laser beam and therefore not be completely removed. The backing may be a metal or ceramic plate or belt, for example. A removable liner on the thermoplastic material delivered to the ablation device is useful to insure clear filter hole formation.

Returning to the embossing station 28 of FIG. 3, it is to be understood that the station 28 pushes a high density array of micro-truncated cones that are pressed into the softened thermoplastic film 10, thereby thinning the regions that will eventually become the filter apertures 20. With respect to this embodiment, it will be appreciated that the micro-indentations may be of any shape, including a truncated shape from the bottom surface toward the top surface, for example, a truncated cone shape. Embossing station 28 may also contain rotary cutting tools that may cut most of the perimeter and other larger features while leaving small tabs to hold the part into the web. Moreover, the perimeter with tabs and other features could be cut with a second rotary die or with a laser scanning cutting system.

In addition, tape could be indexed and die embossing and die (or laser cutting) could be used. Also, a cleaning system (detergent, ultrasonic, wet buffing, drying) could be added prior to returning to the reel to remove any ablation debris. Furthermore, an in-line optical inspection station can check that the filters are clear and of the appropriate size.

In another embodiment, film 10 may comprise a thermoset or UV-cured polymer. The film 10 may be structured by casting a thermoset material on a mandrel and then polymerizing the cast material. In yet another embodiment, the film 10 may be structured by molding the film and then stamping the film 10.

With respect to the ablation process discussed above, it will be appreciated that other removal processes may be employed to remove the thinned areas of the thermoplastic film and produce the filter apertures. For example, in another embodiment, wet chemical etching, such as, for example, a potassium hydroxide etch bath may be used to remove the thinned areas. In another embodiment, plasma etching or reactive ion etching may be another way to remove the thinned areas.

With this said, it will appreciated that, depending on the removal process or device, many types of thermoplastics may be employed. Suitable thermoplastics may, without limitation, include polyetherimide (Ultem), polyetheretherketone (PEEK), thermoplastic polyimide, polyethersulphone, polysulphone, polyamide-imide, and polyphenelyene sulfide. The castable thermoset materials could be from, but not limited to, the classes of epoxies, bismaleimides, and phenolics.

If the microfilter is made from a material like thermoplastic polyimide, it could provide both the microfilter and the adhesive for the assembly of the associated component to which the microfilter connects to, such as, for example, the jet stack plates that are on either side of the inkjet printhead. Other thermoplastics can also provide adhesion to neighboring layers without a separate adhesive. However, separate adhesive layers could also be used in the assembly.

While the invention has been particularly shown and described with reference to particular embodiments, it will be appreciated that variations of the above-disclosed and other features and functions, or alternatives thereof, may be desirably combined into many other different systems or applications. For example, although the embodiments have been described within the context of printer technologies, it should be well understood that the disclosed microfilter and the manufacturing thereof, could clearly be applied in a variety of microfluidic and macrofluidic applications, such as, for example, drug delivery systems, analytical chemistry applications, microchemical reactors and synthesis, genetic engineering technologies, and even homeland security applications.

Also that various presently unforeseen or unanticipated alternatives, modifications, variations or improvements therein may be subsequently made by those skilled in the art which are also intended to be encompassed by the following claims.

What is claimed is:

1. A method of manufacturing a microfilter, comprising:
structuring a thermoplastic film to have a plurality of micro-indentations in which each indentation defines a cavity on a bottom side of the film and a thinned film layer on a top side of the film; and
removing the thinned film layer to form filter apertures in the thermoplastic film.

2. The method of claim 1, wherein said thermoplastic film comprises polyimide thermoplastic material.

3. The method of claim 1, wherein said thermoplastic film is selected from the group consisting of: polyetherimide, polyetheretherketone, thermoplastic polyimide, polyethersulphone, polysulphone, polyamide-imide, and polyphenelyene sulfide.

4. The method of claim 1, wherein said removal of the thinned film layer is performed by a laser ablation technique.

5. The method of claim 4, wherein the laser ablation technique employs an excimer laser.

6. The method of claim 5, wherein the excimer laser comprises at least one of a KrF excimer laser and an XeCl excimer laser.

7. The method of claim 6, wherein ablation fluence of the laser is between about 200 mJ/cm² and about 1000 mJ/cm².

8. The method of claim 6, wherein ablation fluence of the laser is below about 600 mJ/cm².

9. The method of claim 6, wherein energy per pulse of the laser is less than about 500 mJ per pulse.

10. The method of claim 1, wherein the structuring of the thermoplastic film is performed by employing an embossing die.

11. The method of claim 4, wherein the laser is configured to provide enough energy to ablate the micro-indentations to form holes in less than about 20 pulses.

12. A microfilter comprising:
a thermoplastic film having a relatively planar top surface and a relatively planar bottom surface;
the bottom surface comprising a plurality of micro-indentations; and
the top surface comprising a plurality of filter apertures in communication with the bottom surface indentations.

13. The microfilter of claim 12, wherein filter apertures are defined by laser ablated thermoplastic.

14. The microfilter of claim 13, wherein the laser-ablated thermoplastic that define the filter apertures is less than 5 micrometers in thickness.

15. The microfilter of claim 12, wherein the thermoplastic film comprises a polyimide material.

16. The microfilter of claim 12, wherein said thermoplastic film is selected from the group consisting of: polyetherimide, polyetheretherketone, thermoplastic polyimide, polyethersulphone, polysulphone, polyamide-imide, and polyphenelyene sulfide.

17. The microfilter of claim 12, wherein the indentations are truncated along a direction from the bottom surface toward the top surface.

18. The microfilter of claim 12, wherein the indentations are in the form of truncated cones.

19. An ink jet printer comprising:
an ink jet;
a thermoplastic microfilter in communication with the ink jet, the microfilter having a relatively planar top surface and a relatively planar bottom surface, said bottom surface comprising a plurality of indentations, and said top surface comprising a plurality of holes in communication with said bottom surface indentations.
